(19) United States
(12) Patent Application Publication
(10) Pub. No.: US 2013/0000603 A1
(43) Pub. Date: Jan. 3, 2013

(54) EDGE FILTER HAVING MULTIPLE FILTERING OPENINGS

(75) Inventors: STEPHEN WILEY, EAST PEORIA, IL (US); DAVID MARTIN, DUNLAP, IL (US)

(73) Assignee: CATERPILLAR INC., PEORIA, IL (US)

(21) Appl. No.: 13/174,226

(22) Filed: Jun. 30, 2011

(51) Int. Cl. F02M 69/04; F02M 37/22; F02M 61/04

(52) U.S. Cl. 123/445; 239/575; 210/494.1

(57) ABSTRACT

The filter is made of a flat wire with a generally rectangular cross section that has two long sides and two short sides. The flat wire is formed into a generally cylindrical helix defined by successive loops of wire stacked adjacent to one another. For any two successive wire loops, the long sides of the wire loop are set at a predetermined distance from the long side of an adjacent wire loop. Additionally, the short sides of successive wire loops are substantially aligned.

### TECHNICAL FIELD

This patent disclosure relates generally to filters for fluids and, more particularly to an apparatus for filtering.

### BACKGROUND

Internal combustion engines are often used for powering machines such as trucks or tractors in construction, mining, and other applications. Many of these engines use fuel injectors to introduce high pressure fuel into the engine cylinders for combustion. In some fuel injectors, high pressure oil is used to hydraulically pressurize the fuel for injection. The maximum size for debris particles in high pressure oil or fuel used in the engine should be controlled such that damage or plugging of the fuel injectors can be avoided. Filters have been implemented in the past to keep debris out of the fuel injector, but most have shortcomings. Some filters clog relatively quickly, introduce a considerable pressure drop in the fluids passing through them, or are ineffective in sufficiently preventing debris from entering the fuel injector. For example, a simple and common solution is to provide a single, precision width slot at the fuel inlet. This approach is effective at filtering out debris larger than its slot width, but restricts more fluid flow as the slot width is reduced to filter out smaller particles.

### SUMMARY

The disclosure describes, in one aspect, a filter. The filter has at least one flat wire with a generally rectangular cross section. The generally rectangular cross section has a first long side, a second long side, a first short side, and a second short side. The at least one flat wire is formed into a helix that has a generally cylindrical shape. The cylindrical helix is defined by successive loops of wire stacked adjacent one another. For any two adjacent successive wire loops, the first long side of the rectangular cross section of a wire loop is set at a predetermined distance from the second long side of the rectangular cross section of an adjacent wire loop. Additionally, the first short sides of the rectangular cross sections of the wire loop and the adjacent wire loop are substantially aligned. Furthermore, the second short sides of the rectangular cross sections of the wire loop and the adjacent wire loop are substantially aligned.

In another aspect, the disclosure describes a fuel injector. The fuel injector has an injector body with fluid inlets and a fluid outlet formed in the injector body. The fuel injector also has a needle that reciprocates within the injector body. The needle is movable between an open position and a closed position by an actuator that is connected to the injector body. Fuel under pressure is provided from the injector body when the needle is in the open position. A filter is associated with the fluid inlets and configured to filter fluid entering into the injector body through the fluid inlet. The filter has at least one flat wire with a generally rectangular cross section. The generally rectangular cross section has a first long side, a second long side, a first short side, and a second short side. The at least one flat wire is formed into a helix that has a generally cylindrical shape. The cylindrical helix is defined by successive loops of wire stacked adjacent one another. For any two adjacent successive wire loops, the first long side of the rectangular cross section of a wire loop is set at a predetermined distance from the second long side of the rectangular cross section of an adjacent wire loop. Additionally, the first short sides of the rectangular cross sections of the wire loop and the adjacent wire loop are substantially aligned. Furthermore, the second short sides of the rectangular cross sections of the wire loop and the adjacent wire loop are substantially aligned.

Additionally, the disclosure describes an engine. The engine has at least one cylinder with a piston that reciprocates within the cylinder. The cylinder that contains a mixture of air with fuel that enters into the cylinder during operation. The engine includes a fuel injector that provides the fuel to the cylinder. The fuel injector has an injector body with fluid inlets and a fluid outlet formed in the injector body. The fuel injector also has a needle that reciprocates within the injector body. The needle is movable between an open position and a closed position by an actuator that is connected to the injector body. Fuel under pressure is provided from the injector body when the needle is in the open position. A filter is associated with the fluid inlets and configured to filter fluid entering into the injector body through the fluid inlet. The filter has at least one flat wire with a generally rectangular cross section. The generally rectangular cross section has a first long side, a second long side, a first short side, and a second short side. The at least one flat wire is formed into a helix that has a generally cylindrical shape. The cylindrical helix is defined by successive loops of wire stacked adjacent one another. For any two adjacent successive wire loops, the first long side of the rectangular cross section of a wire loop is set at a predetermined distance from the second long side of the rectangular cross section of an adjacent wire loop. Additionally, the first short sides of the rectangular cross sections of the wire loop and the adjacent wire loop are substantially aligned. Furthermore, the second short sides of the rectangular cross sections of the wire loop and the adjacent wire loop are substantially aligned.

### BRIEF DESCRIPTION OF THE DRAWINGS

FIG. 1 is a schematic view of an engine in accordance with the disclosure.

FIG. 2 is a perspective view of a fuel injector with a filter in accordance with the disclosure.

FIG. 3 is a partial perspective view of the fuel injector with the filter of FIG. 2.

FIG. 4 is a perspective view of the filter of FIG. 2.

FIG. 5 is a partial cross-sectional view of the fuel injector with the filter of FIG. 2.

FIG. 6 is a cross section of a filter element in accordance with the disclosure.

### DETAILED DESCRIPTION

In the description that follows, although a filter for use in a fuel injector for an internal combustion engine is used for the purpose of illustration, the structures and methods recited herein are applicable to other devices or systems using filters, such as medical applications, food preparation applications, and others.

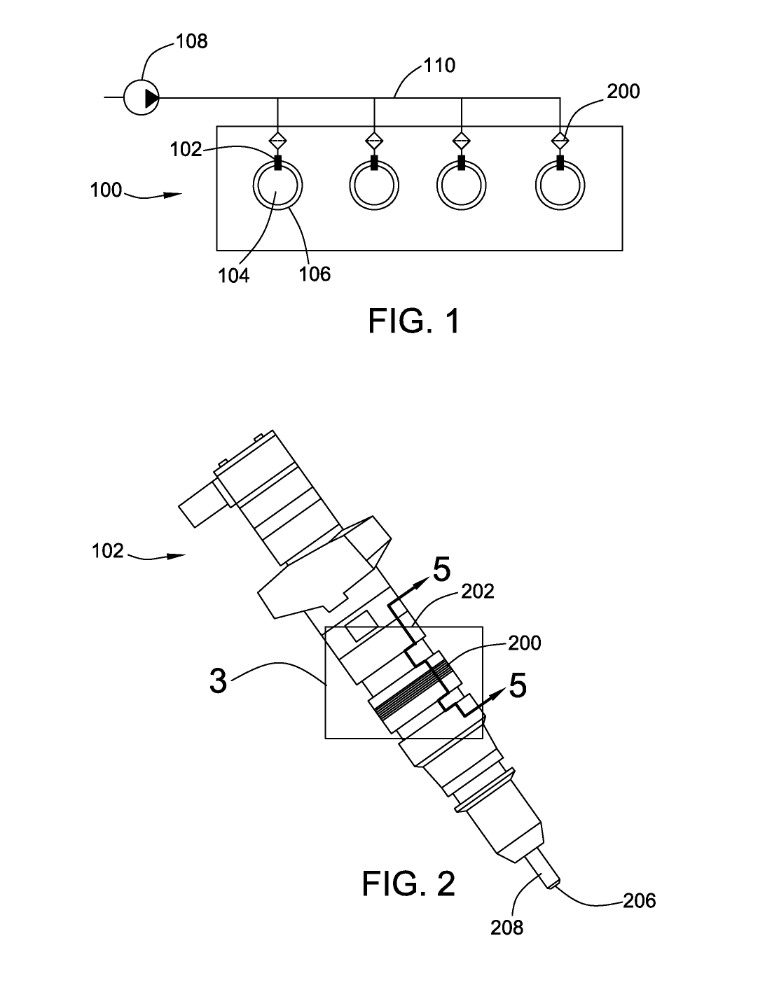

An internal combustion engine 100 having fuel injectors 102, pistons 104, and cylinders 106 is shown in FIG. 1. Although FIG. 1 shows an in-line four-cylinder engine, any number of cylinders arranged in any configuration can be used. As is known, the pistons 104 move reciprocally within the cylinders 106 to compress a mixture of fuel and air that enters into the cylinder during operation. Pressure caused by the reciprocating pistons 104 causes the air-fuel mixture to combust and create a force that powers the pistons 104. The power created by the reciprocating pistons 104 is used to operate the engine 100, which in turn provides power to various components and systems of a machine.

Fuel injectors 102 supply fuel to the cylinders 106. Fuel provided to the cylinders mixes with air for combustion. Each fuel injector 102 has an injector body 202 with an annular groove 204 defined around the injector body's circumference. The injector body 102 includes fluid inlets 205 and a fluid outlet 206. The fluid inlets 205 are in fluid communication with the annular groove 204. Each fuel injector 102 also includes an actuator (not shown) that reciprocates a needle 208 within the injector body 202 between an open position and a closed position.

In the illustrated embodiment, fuel in the fuel injector 102 is pressurized hydraulically by intensification of the pressure of oil provided to the fuel injector at high pressure. Fuel at the intensified pressure is provided to the cylinders 106. The high pressure oil is supplied to the fuel injectors 102 by a pump 108 through high pressure lines 110. The high pressure oil enters each fuel injector 102 through the fluid inlets 205 in the injector body 202. The high pressure oil pressurizes the fuel in a fuel chamber within the fuel injector 102 by applying force to one face of an intensifier piston (not shown), which is configured to hydraulically amplify the oil pressure and impart the intensified pressure to fuel that is injected in the fuel chamber. In one embodiment, when the fuel in the fuel chamber reaches a desired pressure, the actuator in the fuel injector 102 causes the needle 208 to move from the closed position into the open position. With the needle in the open position, a fluid path is created between the fuel chamber and the fluid outlet 206. A predetermined amount of pressurized fuel is forced through the fluid outlet 206 into a cylinder 106 where it mixes with air for combustion.

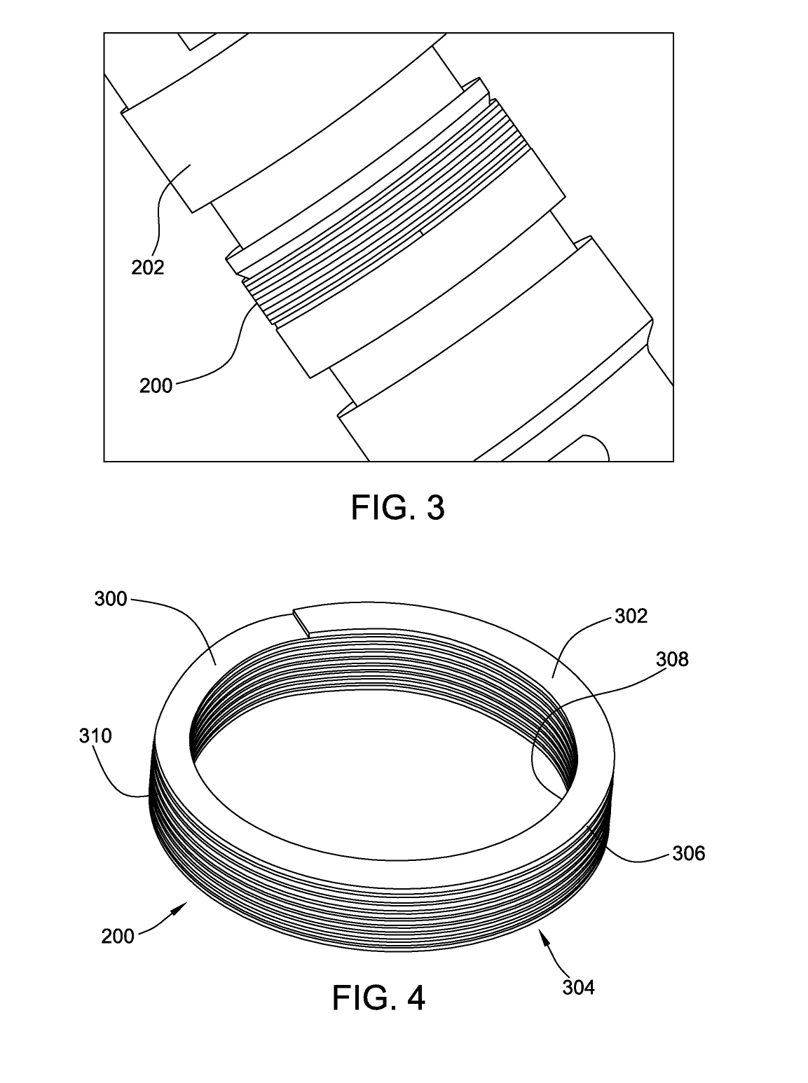

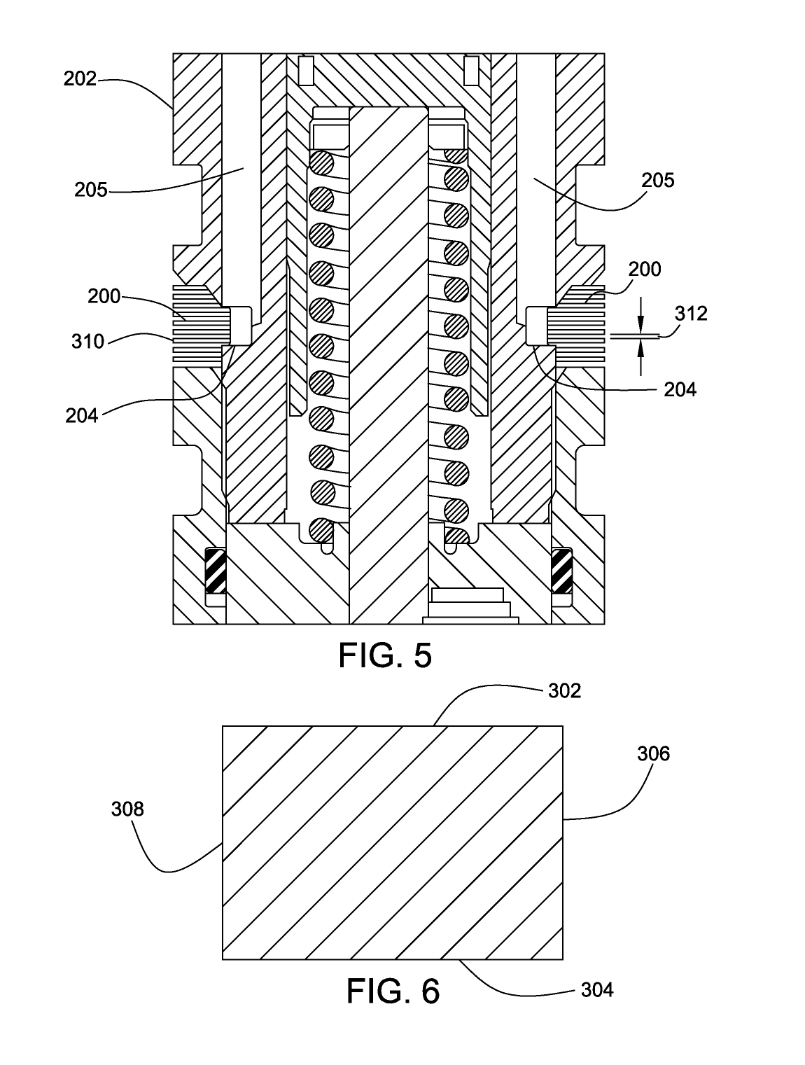

Before the high pressure oil passes through the fluid inlets 205 into the injector body 202, it passes through a filter 200, shown on the injector body 202 in FIG. 2 and FIG. 3. After passing through the filter 200, the oil enters the annular groove 204 and is channeled around the injector body 202 and into the fluid inlets 205. The filter 200, which is best shown in FIG. 4, is made up of a single flat wire 300 with a rectangular cross section, but other cross sections, such as triangular, trapezoidal and the like, may be used. The rectangular cross section, shown in FIG. 6, has a first long side 302, a second long side 304, a first short side 306, and a second short side 308.

In the illustrated embodiment, the first long side 302 and the second long side 304 have a length of about 3 mm, and the first short side 306 and the second short side 308 have a length of about 0.5 mm, but other dimensions can be used. The flat wire 300 is formed into a cylindrical helix. The helix is formed by successive loops 310 of wire stacked adjacent to one another. In each two successive wire loops 310, the first long side 302 of the rectangular cross section is set at a predetermined distance from the second long side 304 of the rectangular cross section of an adjacent wire loop, thus forming a gap or opening 312 between adjacent wire loops. In the illustrated embodiment, the opening 312 is 0.1 mm wide. The cylindrical helix forming the filter 200 has an overall height of about 8 mm, an outer diameter of about 37.5 mm, and an inner diameter of about 31.5 mm, but other dimensions can be used. Moreover, although the filter 200 shown in FIG. 4 is generally cylindrical, other shapes, such as spherical, barrel-shaped, conical, frustoconical, rectangularly prismic and the like, may be used.

As shown in FIG. 4, the first short sides 306 of the rectangular cross section of the wire loop and adjacent wire loop 310 are aligned, and the second short sides 308 of the rectangular cross section of the wire loop and adjacent wire loop are aligned. This alignment of the stacked wire loops 310 creates the cylindrical helix with an outer diameter defined at the first short sides 306 of the rectangular cross section, and an inner diameter defined at the second short sides 308 of the rectangular cross section. The filter 200 surrounds the fuel injector 102 at the annular groove 204, so the size of the cylindrical helix's inner and outer diameter depends on the size of the fuel injector at the annular groove.

Depending on the specific application or fuel injector 102, the content and size of debris in the oil flowing into the fuel injector can be important to the operation and reliability of the injector. For example, debris in the oil can damage the fuel injector 102 and result in failure or unacceptable operation. The size of the opening 312 between each successive wire loop 310 depends upon how sensitive the fuel injector 102 operation is to debris in the oil or other filtered fluid. For the fuel injector 102, this sensitivity depends on its clearances or components, the size of openings and orifices within the fuel injector, and other fuel injector parameters. Larger distances between successive loops 310 will result in allowing larger pieces of debris to flow through the filter 200, while smaller distances between successive loops will filter out smaller debris. The filter 200 prevents certain sized debris from entering the fluid inlets 205 into the fuel injector 102, which helps the fuel injector perform without damage from debris. The size of the opening 312 between the wire loops 310 in the filter 200 can be selected such that very small pieces of debris are filtered. The filter 200 is placed over the fluid entry forming an annular gap between the filter's second short sides 308 and the filter's first short sides 306, where the fluid enters the filter at the multiple openings 312. This arrangement provides a much larger effective filtering area than a single slot opening at a fluid inlet. This increased filtering area supports higher flow rates than are possible with traditional single-slot filters while filtering out smaller pieces of debris. Because the filter 200 is made up of multiple wire loops 310 and multiple corresponding openings 312 between those loops, adequate oil volume enters into the fuel injector 102 for proper operation. In the illustrated embodiment, the filter 200 is used to filter oil provided at a pressure of about 25 MPa, at a flow rate of about 0.5 gallons per minute. The edge filter opening 312 size is about 0.1 mm wide, but other values may be used.

Alternatively, the filter 200 could be positioned on the fuel injector 102 to filter fuel before the fuel enters a fuel injector at fuel fluid inlets instead of or in addition to oil fluid inlets. This could occur either in a fuel injector that requires fuel free of debris, in a fuel injector that does not use high pressure oil to pressurize the fuel, or both. The filter 200 is place at the fuel's fluid inlets and, depending on the opening 312 between the filter's wire loops 310, certain sized debris is prevented from entering the fuel injector 102. The fuel itself enters the fuel injector 102, so filtering the fuel as it enters the fuel injector helps to prevent damage and ensure acceptable operation.

While the arrangement is illustrated in connection with a truck or tractor, the arrangement disclosed herein has universal applicability in various other types of machines as well. The term “machine” may refer to any machine that performs some type of operation associated with an industry such as mining, construction, farming, transportation, or any other industry known in the art. For example, the machine may be an earth-moving machine, such as a wheel loader, excavator, dump truck, backhoe, motor grader, material handler or the like. Moreover, an implement may be connected to the machine. Such implements may be utilized for a variety of tasks, including, for example, loading, compacting, lifting, brushing, and include, for example, buckets, compactors, forked lifting devices, brushes, grapples, cutters, shears, blades, breakers/hammers, augers, and others.

### INDUSTRIAL APPLICABILITY

The industrial applicability of the apparatus for an edge filter having multiple filter openings as described herein should be readily appreciated from the foregoing discussion. The present disclosure is applicable in any type of application where a fluid must be filtered. It is particularly useful in fuel injectors that use high pressure oil to hydraulically pressurize fuel for injection in an internal combustion engine. In this application, a filter must adequately prevent debris in the oil from entering the fuel injector, while at the same time not clogging and allowing adequate oil volume to pass into the fuel injector for operation.

Further, the apparatus above can be adapted to a large variety of applications in a large variety of engines and machines. For example, any type of industrial machine with an engine can utilize the apparatus, such as backhoe loaders, compactors, feller bunchers, forest machines, industrial loaders, wheel loaders, trucks, tractors and many other machines can benefit from the systems described.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A filter comprising:
at least one flat wire having a generally rectangular cross section, the generally rectangular cross section having a first long side, a second long side, a first short side, and a second short side;
wherein the at least one flat wire is formed into a helix having a generally cylindrical shape that is defined by successive loops of wire stacked adjacent one another such that for any two adjacent successive wire loops:
the first long side of the rectangular cross section of a wire loop is set at a predetermined distance from the second long side of the rectangular cross section of an adjacent wire loop;
the first short sides of the rectangular cross sections of the wire loop and the adjacent wire loop are substantially aligned; and
the second short sides of the rectangular cross sections of the wire loop and the adjacent wire loop are substantially aligned.

2. The filter of claim 1, wherein the first long side and the second long side have a length of 3 mm, and the first short side and the second short side have a length of 0.5 mm.

3. The filter of claim 1, wherein the filter is made from a single flat wire.

4. A fuel injector comprising:
an injector body;
an annular groove formed on the injector body;
at least one fluid inlet formed in the injector body in fluid communication with the annular groove;
a fluid outlet formed on the injector body;
a needle reciprocally disposed within the injector body, the needle being selectively movable between an open position and a closed position by an actuator connected to the injector body, wherein fuel under pressure is provided from the injector body when the needle is in the open position; and
a filter associated with the fluid inlets and configured to filter fluid entering into the injector body through the fluid inlets, the filter comprising:
at least one flat wire having a generally rectangular cross section, the generally rectangular cross section having a first long side, a second long side, a first short side, and a second short side;
wherein the at least one flat wire is formed into a helix having a generally cylindrical shape that is defined by successive loops of wire stacked adjacent one another such that for any two adjacent successive wire loops:
the first long side of the rectangular cross section of a wire loop is set at a predetermined distance from the second long side of the rectangular cross section of an adjacent wire loop;
the first short sides of the rectangular cross sections of the wire loop and the adjacent wire loop are substantially aligned; and
the second short sides of the rectangular cross sections of the wire loop and the adjacent wire loop are substantially aligned.

5. The filter of claim 4, wherein the first long side and the second long side have a length of 3 mm, and the first short side and the second short side have a length of 0.5 mm.

6. The fuel injector of claim 4, wherein filter is made from a single flat wire.

7. The fuel injector of claim 4, wherin the fluid inlets are oil inlets.

8. The fuel injector of claim 7, wherein high pressure oil is introduced into the fluid inlet.

9. The fuel injector of claim 8, wherein the high pressure oil is used to pressurize fuel in the fuel injector.

10. The fuel injector of claim 4, wherein the fluid inlets are a fuel inlets.

11. The fuel injector of claim 10, wherein high pressure fuel is introduced into the fluid inlet.

12. An engine comprising:
at least one cylinder;
a piston reciprocally disposed within the at least one cylinder, the at least one cylinder configured to contain a mixture of air that enters into the cylinder with fuel provided to the cylinder during operation;
a fuel injector configured to provide the fuel to the at least one cylinder, the fuel injector comprising:
an injector body;
an annular groove formed on the injector body;
at least one fluid inlet formed in the injector body in fluid communication with the annular groove;
a fluid outlet formed on the injector body
a needle reciprocally disposed within the injector body, the needle being selectively movable between an open position and a closed position by an actuator connected to the injector body, wherein fuel under pressure is provided from the injector body when the needle is in the open position; and
a filter associated with the fluid inlets and configured to filter fluid entering into the injector body through the fluid inlets, the filter comprising:
at least one flat wire having a generally rectangular cross section, the generally rectangular cross section having a first long side, a second long side, a first short side, and a second short side;
wherein the at least one flat wire is formed into a helix having a generally cylindrical shape that is defined by successive loops of wire stacked adjacent one another such that for any two adjacent successive wire loops:
the first long side of the rectangular cross section of a wire loop is set at a predetermined distance from the second long side of the rectangular cross section of an adjacent wire loop;
the first short sides of the rectangular cross sections of the wire loop and the adjacent wire loop are substantially aligned; and
the second short sides of the rectangular cross sections of the wire loop and the adjacent wire loop are substantially aligned.

13. The engine of claim 12, wherein the first long side and the second long side have a length of 3 mm, and the first short side and the second short side have a length of 0.5 mm.

14. The engine of claim 12, wherein the filter is made from a single flat wire.

15. The engine of claim 12, wherin the fluid inlets are oil inlets.

16. The engine of claim 15, wherein high pressure oil is introduced into the fluid inlet.

17. The engine of claim 16, wherein the high pressure oil is used to pressurize fuel in the fuel injector.

18. The engine of claim 17, wherein the fuel is introduced into the cylinder through the fluid outlet.

19. The engine of claim 12, wherein the fluid inlets are fuel inlets.

20. The engine of claim 12, wherein high pressure fuel is introduced into the fluid inlet.
